(19) United States
(12) Patent Application Publication
(10) Pub. No.: US 2011/0083332 A1
(43) Pub. Date: Apr. 14, 2011

(54) COMBINED SCALE

(76) Inventor: NAZIM TEMIZ, Westlake, OH (US)

(21) Appl. No.: 12/575,487

(22) Filed: Oct. 8, 2009

(51) Int. Cl. B43L 7/00

(52) U.S. Cl. 33/494

(57) ABSTRACT

A combined scale has nine wings, which are assembled around core cylinder in rotatable manner by rings. Core cylinder fixed to edge supporters on each side. Varied scale markings are machined along each side of the wings. The scales are identified by markings at the ends of each side of the wings for ease in selecting particular desired scale.

### BACKGROUND OF THE INVENTION

1. Field of the Invention

Presented invention relates generally to combined architects', engineers' and metric scales.

2. Prior Art Statement

Even though, nowadays, architects and engineers work with computer aided design programs to create new projects, many projects include modifications or expansions of existing structures. Scales are popular instrument to work on project and many projects require work more than one scale such as architects' scale and engineers' scale. The scales are usually triangular in cross section. Each face of triangle having two scales machined along each edge.

U.S. Pat. No. 3,845,563 to Umeyuki Taniquchi, combined scales joined by two hinges at longitudinal edges.

Working with combined scales is desirable but holding three scales at the same time is not.

### SUMMARY OF THE INVENTION

The present invention has nine wings, which are assembled around core cylinder in rotatable manner by staggered rings. Core cylinder fixed to edge supporters on each side. Varied scale markings are machined along each side of the wings. The scales are identified by markings at the ends of each side of the wings for ease in selecting particular desired scale.

It is an object of the presented invention to provide architect's, engineers' and metric scales in one instrument.

### BRIEF DESCRIPTION OF THE DRAWINGS

The present invention will be better understood from following description, and also taken in conjunction with the accompanying drawing in which,

FIG. 1 is a perspective view of the present invention

FIG. 2 is a blow up perspective view of core cylinders and edge supporters

FIG. 3 is front view of the present invention

FIG. 4 is a cross sectional view of the present invention taken along lines A-A in FIG. 3

FIG. 5 is side view of edge supporters

FIG. 6 is a cross sectional view of edge supporters taken along lines C-C in FIG. 5

FIG. 7 is a cross sectional view of the present invention taken along lines B-B in FIG. 3

FIG. 8 is side view of core cylinder

FIG. 9 is front view of core cylinder

FIG. 10 is side view of wings

FIG. 11, FIG. 12, FIG. 13, FIG. 14, FIG. 15, FIG. 16, FIG. 17, FIG. 18 and FIG. 19 are front view of wings

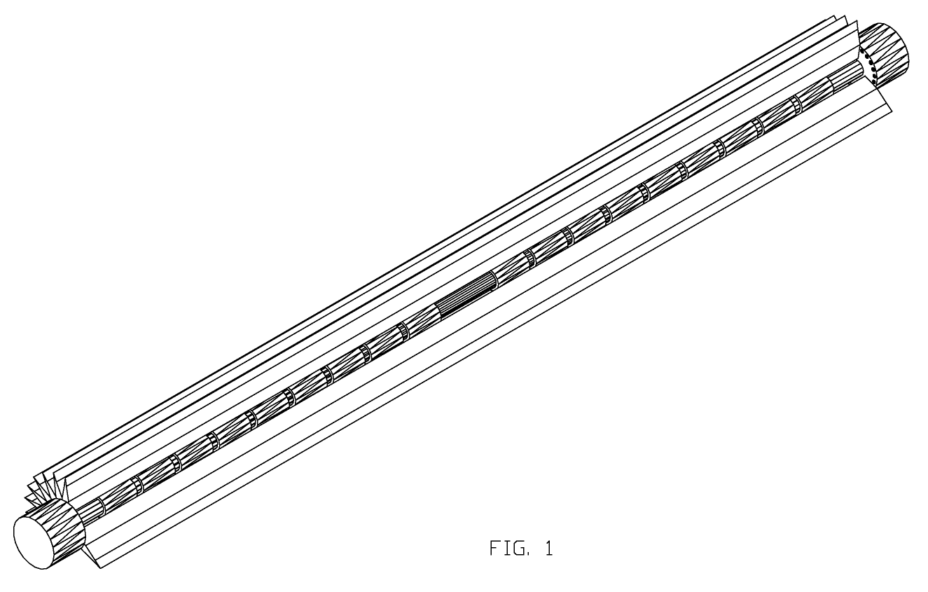

### DETAILED DESCRIPTION OF THE INVENTION

Referring FIG. 11 thru FIG. 19 there are nine wings 3 having a straight edges with staggered two rings 3b on each said wings. Along each of the straight edges is a series of equally spaced major division line markings. The distance between each division line marking is in a fixed proportion with respect to one unit length.

Referring FIG. 11 there is major division line markings represent to one-half of a foot distance. Distance between the major division line markings in FIG. 11 is one eight of an inch. This side of the wing 3 can be used as one-fourth of an inch equals to one foot distance scale if it is read from left to right and same side of the wing 3 can be used as one-eighth of an inch equals to one foot distance scale if it is read from right to left. Wings 3 with said division-marking technique allows having thirty-six different scales on the presented invention. Three wings 3 assigned for each type of scales, which are architects' scales, engineers' scales and metric scales.

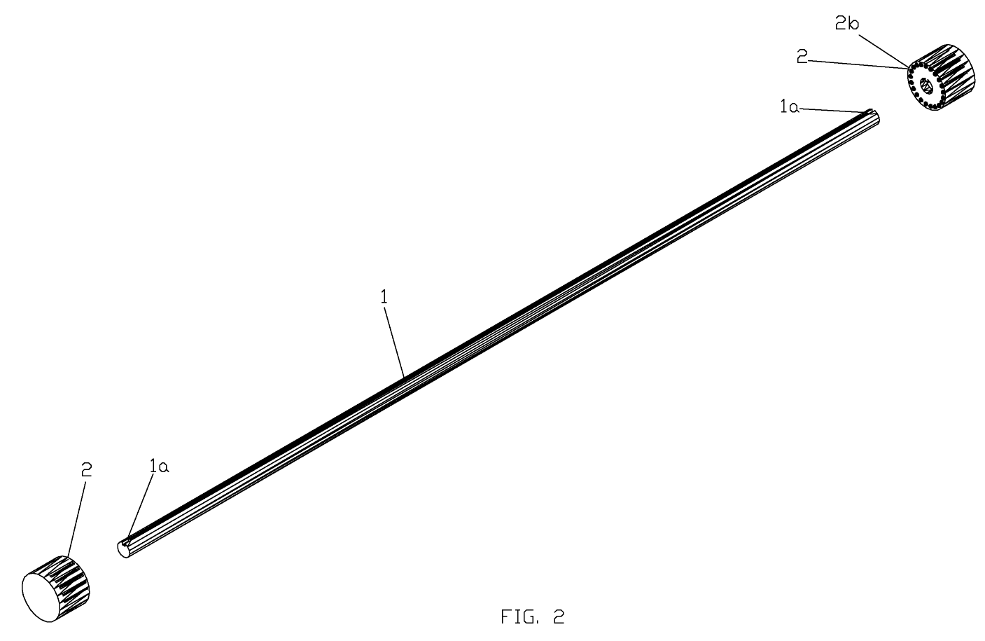

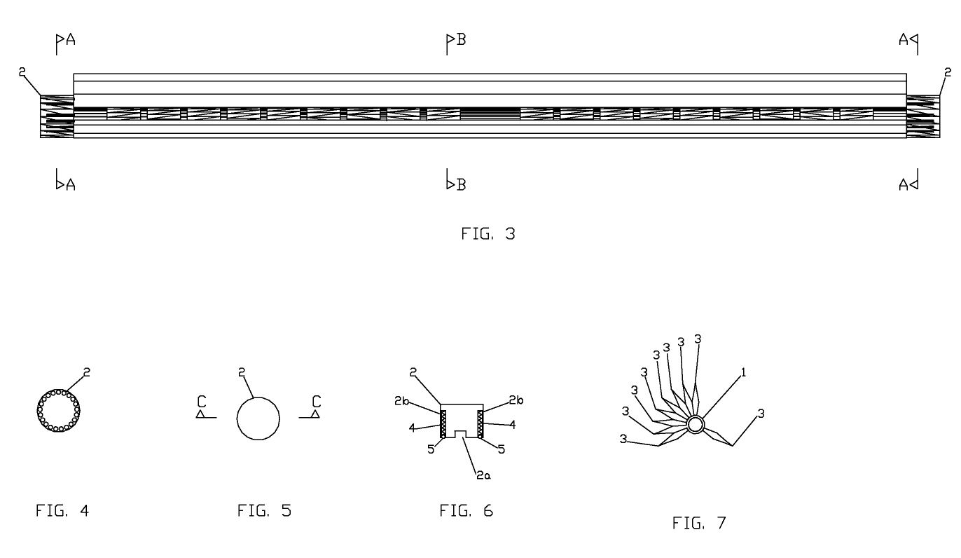

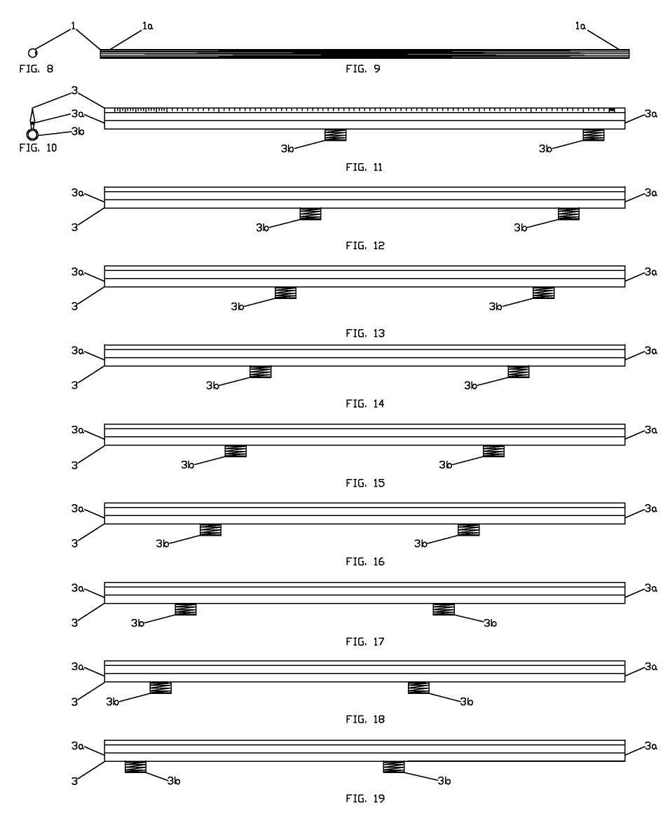

The rings 3b are aligned by core cylinder 1 to keep said wings 3 together in rotatable manner. Referring FIG. 4 and FIG. 5 there is edge supporter 2, which comprises twenty-one springs 4 and twenty-one fixing spheres 5 in cylindrical spring housings 2b. Said spheres stick out from said spring housing 2b via circular slot, which is smaller than said fixing spheres 5. Said springs 4 push said fixing spheres 5 outwards to fasten said wings 3. Said wings contains spherical pit 3a at the each end to fix said wings 3 in selecting particular desired scale. Referring FIG. 2 FIG. 6 and FIG. 9 said end supporters 2 and core cylinder 1 has a notch 2b and la to align fixing spheres 5 reciprocally.

Wing 3 with desired scale marking can be set hundred twenty degrees away from the others as shown in FIG. 7 to use.

What is claimed is:

1. A combined scale comprising nine wings, which are assembled around core cylinder in rotatable manner by rings. Core cylinder fixed to edge supporters on each side. Varied scale markings are machined along each side of the wings. The scales are identified by markings at the ends of each side of the wings for ease in selecting particular desired scale.

2. A combined scale of claim 1, wherein said wings have division line markings along all edges. Said line markings are found on independent architects' scales, engineers' scales and metric scales.

3. A combined scale of claim 1, wherein said edge supporters comprising springs and fixing spheres.
